(19) United States
(12) Patent Application Publication
(10) Pub. No.: US 2014/0052278 A1
(43) Pub. Date: Feb. 20, 2014

(54) SENSING AND ADJUSTING FEATURES OF AN ENVIRONMENT

(71) Applicant: The Procter & Gamble Company, Cincinnati, OH (US)

(72) Inventors: Kenneth Stephen McGuire, Cincinnati, OH (US); Erik John Hasenoehrl, Loveland, OH (US); William Paul Mahoney, III, Liberty Township, OH (US); Corey Michael Bischoff, Cincinnati, OH (US); Huiqing Y. Stanley, Mason, OH (US); Mark John Steinhardt, Cincinnati, OH (US); Dana Paul Gruenbacher, Fairfield, OH (US)

(73) Assignee: The Procter & Gamble Company, Cincinnati, OH (US)

(21) Appl. No.: 14/063,030

(22) Filed: Oct. 25, 2013

Related U.S. Application Data
(63) Continuation-in-part of application No. 29/390,527, filed on Apr. 26, 2011, now Pat. No. D689630.
Application No. 29/390,527 is a continuation-in-part of application No. 29/390,535, filed on Apr. 26, 2011, now Pat. No. D683483.

(30) Foreign Application Priority Data
Apr. 26, 2011 (WO) US2011/033904
Apr. 26, 2011 (WO) US2011/033907
Apr. 26, 2011 (WO) US2011/033910
Apr. 26, 2011 (WO) US2011/033918
Apr. 26, 2011 (WO) US2011/033924

(51) Int. Cl. G05B 15/02; H05B 37/02

(52) U.S. Cl. CPC G05B 15/02; H05B 37/02
USPC 700/90; 315/149; 315/152

(57) ABSTRACT

Included are embodiments for sensing and adjusting features of an environment. Some embodiments include a system and/or method that for receiving an ambiance feature of a source environment, determining from the ambiance feature, a source output provided by a source device in the source environment, and determining an ambiance capability for a target environment. Some embodiments include determining, based on the ambiance capability, a target output for a target device in the target environment and communicating with the target device to model the ambiance feature from the source environment into the target environment by altering the target output provided by the target device.

### FIELD OF THE INVENTION

The present application relates generally to sensing and adjusting features of an environment and specifically to utilizing a computing device to determine features of a first environment for utilization in a second environment.

### BACKGROUND OF THE INVENTION

Often a user will enter a first environment, such as a house, room, restaurant, hotel, office, etc. and an ambiance of that environment is found to be desirable. The features of the ambiance may include the lighting, sound, temperature, humidity, air quality, scent, etc. The user may then enter a second environment and desire to replicate ambiance from the first environment in that second environment. However, in order to replicate the ambiance of the first environment, the user may be forced to manually adjust one or more different settings in the second environment. Additionally, when the user is adjusting the settings he/she may be forced to refer only to his or her memory to implement the setting from the first environment. Further, as the second environment may include different light sources, heating systems, air conditioning systems, audio systems, etc., a user's attempt to manually replicate the ambiance from the first environment is often difficult if not futile.

### SUMMARY OF THE INVENTION

Included are embodiments of a method for sensing and adjusting features of an environment. Some embodiments of the method are configured for receiving an ambiance feature of a source environment, determining from the ambiance feature, a source output provided by a source device in the source environment, and determining an ambiance capability for a target environment. Some embodiments include determining, based on the ambiance capability, a target output for a target device in the target environment and communicating with the target device to model the ambiance feature from the source environment into the target environment by altering the target output provided by the target device.

Also included are embodiments of a system. Some embodiments of the system include an image capture device for receiving an illumination signal for a source environment and a memory component that stores logic that causes the system to receive the illumination signal from the image capture device and determine, from the illumination signal, an illumination ambiance in the source environment. In some embodiments, the logic further causes the system to determine a characteristic of the source environment, and determine an illumination capability for a target environment. In still some embodiments, the logic causes the system to determine, based on the illumination capability, a target output for a light source in the target environment and communicate with the light source to model the illumination ambiance from the source environment into the target environment by altering the target output provided by the light source.

Also included are embodiments of a non-transitory computer-readable medium. Some embodiments of the non-transitory computer-readable medium include logic that causes a computing device to receive an illumination signal, determine, from the illumination signal, an illumination ambiance in a source environment, and determine a characteristic of the source environment. In some embodiments, the logic further causes the computing device to determine an illumination capability for a target environment, determine, based on the illumination capability, a target output for a light source in the target environment, and communicate with the light source to model the illumination ambiance from the source environment into the target environment by altering the target output provided by the light source. In still some embodiments, the logic causes the computing device to receive an updated lighting characteristic of the target environment, determine whether the updated lighting characteristic substantially models the illumination ambiance from the source environment, and in response to determining that the updated lighting characteristic does not substantially model the illumination ambiance from the source environment, altering the target output provided by the light source.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 depicts a plurality of environments from which an ambiance may be sensed and adjusted, according to embodiments disclosed herein;

FIG. 2 depicts a user computing device that may be utilized for sensing and adjusting features in an environment, according to embodiments disclosed herein;

FIG. 3 depicts a user interface that provides options to model an environment ambiance and apply a stored model, according to embodiments disclosed herein;

FIG. 4 depicts a user interface for determining a type of ambiance feature to capture in an environment, according to embodiments disclosed herein;

FIG. 5 depicts a user interface for receiving data from a source environment, according to embodiments disclosed herein;

FIG. 6 depicts a user interface for modeling the source environment, according to embodiments disclosed herein;

FIG. 7 depicts a user interface for storing a received ambiance, according to embodiments disclosed herein;

FIG. 8 depicts a user interface for receiving a theme from an environment, according to embodiments disclosed herein;

FIG. 9 depicts a user interface for applying a stored ambiance to a target environment, according to embodiments disclosed herein;

FIG. 10 depicts a user interface for receiving an ambiance capability for a target environment, according to embodiments disclosed herein;

FIG. 11 depicts a user interface for providing a suggestion to more accurately model the target environment according to the source environment, according to embodiments disclosed herein;

FIG. 12 depicts a user interface for providing options to apply additional ambiance features to the target environment, according to embodiments disclosed herein;

FIG. 13 depicts a flowchart for modeling an ambiance feature in a target environment, according to embodiments disclosed herein;

FIG. 14 depicts a flowchart for determining whether an ambiance feature has previously been stored, according to embodiments disclosed herein; and

FIG. 15 depicts a flowchart for determining whether an applied ambiance feature substantially matches a theme, according to embodiments disclosed herein.

### DETAILED DESCRIPTION OF THE INVENTION

Embodiments disclosed herein include systems and methods for sensing and adjusting features in an environment. More specifically, in some embodiments, a user may enter a source environment, such as a house, room, office, hotel, restaurant, etc. and realize that the ambiance is pleasing. The ambiance may include the lighting, the sound, the scent, the climate, and/or other features of the source environment. Accordingly, the user may utilize a user computing device, such as a mobile phone, personal digital assistant (PDA), laptop computer, tablet computer, etc. to capture an ambiance feature of the source environment. More specifically, the user computing device may include (or be coupled to a device that includes) an image capture device, a microphone, a gyroscope, an accelerometer, a positioning system, a thermometer, a humidity sensor, an air quality sensor, and/or other sensors for determining the ambiance features of the source environment. As an example, if the user determines that the lighting in the source environment is appealing, the user may select an option on the user computing device that activates the image capture device. The image capture device may capture lighting characteristics of the source environment. The lighting characteristics may include a light intensity, a light frequency, a light distribution, etc., as well as dynamic changes over time thereof. With this information, the user computing device can determine a source output, which (for lighting) may include a number of light sources, a light output of sources; whether the light is diffuse light, columnar light, direct light, reflected light, color temperature of the light, overall brightness, etc. The user computing device may also determine a characteristic of the source environment, such as size, coloring, acoustics, and/or other characteristics. Once the user computing device has determined the source output, this data may be stored locally and/or sent to a remote computing device for storage.

Once a source output is determined, the user device may implement the ambiance from the source environment into a target environment. In the lighting context, the user may utilize the image capture device (and/or other components, such as the positioning system, gyroscope, accelerometer, etc.) to determine an ambiance capability (such as an illumination capability in the lighting context or an audio capability, a scent capability, a climate capability, etc. in other contexts) of the target environment. Again, in the lighting context, the ambiance capability may be determined from a number and position of target devices (such as light sources or other output devices), windows, furniture, and/or other components. Other features of the target environment may also be determined, such as size, global position, coloring, etc.

Additionally, the user computing device can determine alterations to make to the light sources in the target environment to substantially model the ambiance feature from the source environment. This determination may be made by comparing the location and position of the output sources in the source environment, as well as the light actually realized from those output sources with the determined ambiance capability of the target environment. As an example, if the source environment is substantially similar to the target environment, the user computing device can determine that the output (such as lighting effects) provided by the light sources should be approximately the same. If there are differences between the source environment and the target environment, those differences may be factored into the analysis. More specifically, when the source environment and target environment are different, the combination of light output and room dynamics adds up to the visual feeling of the environment. For example, because the source environment and the target environment are different, the light outputs could be substantially different. However, due to room size, reflective characteristics, wall color etc., of the source environment and the target environment, embodiments disclosed herein may shape the light output such that the ambiance “felt” by the image capture device would be similar. As such, some embodiments may utilize a feedback loop configuration to dynamically assess the source environment and/or target environment and dynamically adjust the settings and ensure accuracy.

Once the alterations are determined, the user computing device can communicate with the output sources directly and/or with a network component that controls the output sources. The user computing device may additionally reexamine the target environment to determine whether the adjustments made substantially model the ambiance feature from the source environment. If not, further alterations may be made. If the alterations are acceptable, the settings for this ambiance may be stored.

It should be understood that in some embodiments where the source output data (which includes data about the ambiance characteristics in the source environment) is sent to a remote computing device, the remote computing device may receive the source output data and create an application to send to the user computing device for implementing the ambiance into a target environment. This may be accomplished such that the ambiance may be implemented in any environment (with user input on parameters of the target environment). Similarly, in some embodiments, the user computing device may additionally send environmental characteristics data (such as size, shape, position, etc. of an environment), such that the remote computing device can create an application to implement the ambiance in the particular target environment.

Additionally, some embodiments may be configured with a feedback loop for continuous and/or repeated monitoring and adjustment of settings in the target environment. More specifically, the user computing device may be configured to take a plurality of measurements of the source environment to determine a current ambiance. Similarly, when modeling the current ambiance into the target environment, the user computing device can send data related to the current ambiance to a target device. Additionally, once the adjustments to the target environment are implemented, the user computing device can monitor the ambiance, calculate adjustments, and send those adjustments to achieve a desired target ambiance. This may continue a predetermined number of iterations or until accuracy is achieved within a predetermined threshold.

It should also be understood that, as described herein, embodiments of a light source may include any component that provides a visible form of light, including a lamp, an overhead light, a television, a component light, sunlight, a fire, an external light source, and a candle, etc. Thus, a light source may take many shapes, sizes, and forms and, since the inception of electric lighting, have matured to include many types of emission sources. Incandescence, electroluminescence, and gas discharge have each been used in various lighting apparatus and, among each the primary emitting element (e.g., incandescent filaments, light-emitting diodes, gas, plasma, etc.) may be configured in any number of ways according to the intended application. Many embodiments of light sources described herein are susceptible to use with almost any type of emission source, as will be understood by a person of ordinary skill in the art upon reading the following described embodiments.

For example, certain embodiments may include light-emitting diodes (LEDs), LED light sources, lighted sheets, and the like. In these embodiments, a person of ordinary skill in the art will readily appreciate the nature of the limitation (e.g., that the embodiment contemplates a planar illuminating element) and the scope of the described embodiment (e.g., that any type of planar illuminating element may be employed). LED lighting arrays come in many forms including, for instance, arrays of individually packaged LEDs arranged to form generally planar shapes (i.e., shapes having a thickness small relative to their width and length). Arrays of LEDs may also be formed on a single substrate or on multiple substrates, and may include one or more circuits (i.e., to illuminate different LEDs), various colors of LEDs, etc. Additionally, LED arrays may be formed by any suitable semiconductor technology including, by way of example and not limitation, metallic semiconductor material and organic semiconductor material. In any event, embodiments utilizing an LED material or the use of a planar illuminated sheet, any suitable technology known presently or later invented may be employed in cooperation with other elements without departing from the spirit of the disclosure.

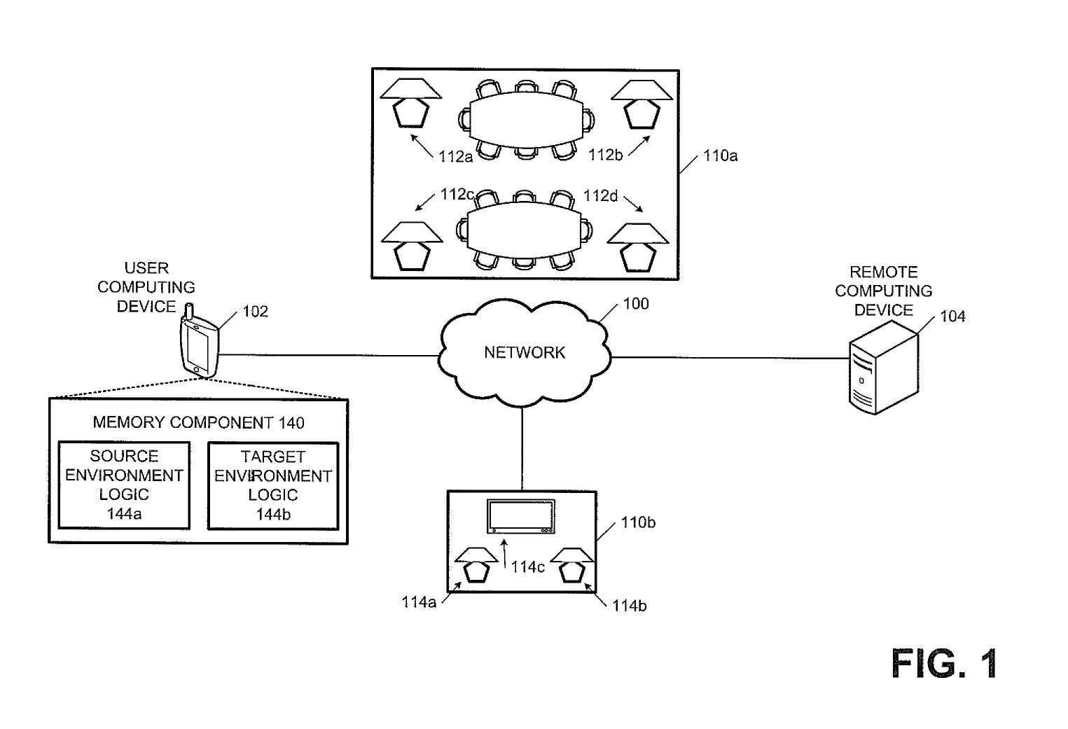

Referring now to the drawings, FIG. 1 depicts a plurality of environments from which an ambiance may be sensed and adjusted, according to embodiments disclosed herein. As illustrated in FIG. 1, a network 100 may include a wide area network, such as the Internet, a local area network (LAN), a mobile communications network, a public service telephone network (PSTN) and/or other network and may be coupled to a user computing device 102, remote computing device 104, and a target environment 110b. Also included is a source environment 110a. The source environment 110a may include one or more output devices 112a-112d, which in FIG. 1 are depicted as light sources. As discussed above, a light source may include any component that provides a visible form of light, including a lamp, an overhead light, a television, a component light, sunlight, a fire, an external light source, a candle, etc.

Similarly, the target environment 110b may also include one or more output devices 114a-114c. While the output devices 112 and 114 are illustrated as light sources in FIG. 1 that provide an illumination ambiance, other sources may also be considered within the scope of this disclosure, including an audio source, a scent source, climate source (such as a temperature source, a humidity source, an air quality source, wind source, etc.) and/or other sources. As illustrated, in some embodiments, the source environment 110a and target environment 110b may each be coupled to the network 100, such as via a network device. The network device may include any local area and/or wide area device for controlling an output device in an environment. Such network devices may be part of a “smart home” and/or other intelligent system. From the source environment 110a, the network connection may allow the user computing device 102 with a mechanism for receiving an ambiance theme and/or other data related to the source environment 110a. Similarly, by coupling to the network 100, the target environment 110b may provide the user computing device 102 with a mechanism for controlling one or more of the output devices 114. Regardless, it should be understood that these connections are merely examples, as either or both may or may not be coupled to the network 100.

Additionally, the user computing device 102 may include a memory component 140 that stores source environment logic 144a for functionality related to determining characteristics of the source environment 110a. The memory component 140 also stores target environment logic 144b for modeling the ambiance features from the source environment 110a and applying those ambiance features into the target environment 110b.

It should be understood that while the user computing device 102 and the remote computing device 104 are depicted as a mobile computing device and server respectively, these are merely examples. More specifically, in some embodiments any type of computing device (e.g. mobile computing device, personal computer, server, etc.) may be utilized for either of these components. Additionally, while each of these computing devices 102, 104 is illustrated in FIG. 1 as a single piece of hardware, this is also an example. More specifically, each of the computing devices 102, 104 depicted in FIG. 1 may represent a plurality of computers, servers, databases, etc.

It should also be understood that while the source environment logic 144a and the target environment logic 144b are depicted in the user computing device 102, this is also just an example. In some embodiments, the user computing device 102 and/or the remote computing device 104 may include this and/or similar logical components.

Further, while FIG. 1 depicts embodiments in the lighting context, other contexts are included within the scope of this disclosure. As an example, while the user computing device 102 may include a scent sensor, in some embodiments a scent sensor may be included in an air freshener (or other external device) that is located in the source environment 110a and is in communication with the user computing device 102. The air freshener may determine an aroma in the source environment 110a and may communicate data related to that aroma to the user computing device 102. Similarly, in some embodiments, the air freshener may be set to produce an aroma and may send data related to the settings for producing that aroma. In the target environment 110b, another air freshener may be in communication with the user computing device 102 for providing the aroma data received from the source environment 110a. With this information, the air freshener may implement the aroma to model the ambiance from the source environment 110a.

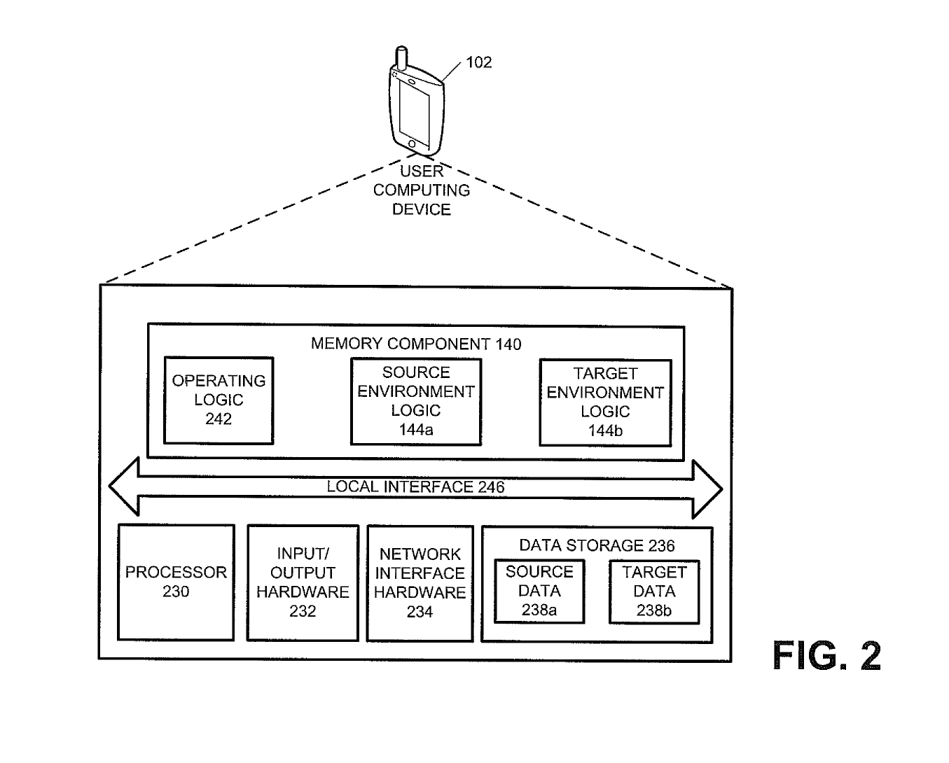

FIG. 2 depicts a user computing device 102 that may be utilized for sensing and adjusting features in an environment, according to embodiments disclosed herein. In the illustrated embodiment, the user computing device 102 includes at least one processor 230, input/output hardware 232, network interface hardware 234, a data storage component 236 (which includes product data 238a, user data 238b, and/or other data), and the memory component 140. The memory component 140 may be configured as volatile and/or nonvolatile memory and, as such, may include random access memory (including SRAM, DRAM, and/or other types of RAM), flash memory, secure digital (SD) memory, registers, compact discs (CD), digital video discs (DVD), and/or other types of non-transitory computer-readable mediums. Depending on the particular embodiment, these non-transitory computer-readable mediums may reside within the user computing device 102 and/or external to the user computing device 102.

Additionally, the memory component 140 may be configured to store operating logic 242, the source environment logic 144a, and the target environment logic 144b. The operating logic 242 may include an operating system, basic input output system (BIOS), and/or other hardware, software, and/or firmware for operating the user computing device 102. The source environment logic 144a and the target environment logic 144b may each include a plurality of different pieces of logic, each of which may be embodied as a computer program, firmware, and/or hardware, as an example. A local interface 246 is also included in FIG. 2 and may be implemented as a bus or other interface to facilitate communication among the components of the user computing device 102.

The processor 230 may include any processing component operable to receive and execute instructions (such as from the data storage component 236 and/or memory component 140). The input/output hardware 232 may include and/or be configured to interface with a monitor, positioning system, keyboard, mouse, printer, image capture device, microphone, speaker, gyroscope, accelerometer, compass, thermometer, humidity sensor, air quality sensor and/or other device for receiving, sending, and/or presenting data. The network interface hardware 234 may include and/or be configured for communicating with any wired or wireless networking hardware, including an antenna, a modem, LAN port, wireless fidelity (Wi-Fi) card, WiMax card, mobile communications hardware, and/or other hardware for communicating with other networks and/or devices. From this connection, communication may be facilitated between the user computing device 102 and other computing devices. The processor 230 may also include and/or be coupled to a graphical processing unit (GPU).

It should be understood that the components illustrated in FIG. 2 are merely exemplary and are not intended to limit the scope of this disclosure. As an example, while the components in FIG. 2 are illustrated as residing within the user computing device 102, this is merely an example. In some embodiments, one or more of the components may reside external to the user computing device 102. It should also be understood that, while the user computing device 102 in FIG. 2 is illustrated as a single device, this is also merely an example. In some embodiments, the source environment logic 144a and the target environment logic 144b may reside on different devices. Additionally, while the user computing device 102 is illustrated with the source environment logic 144a and the target environment logic 144b as separate logical components, this is also an example. In some embodiments, a single piece of logic may perform the described functionality.

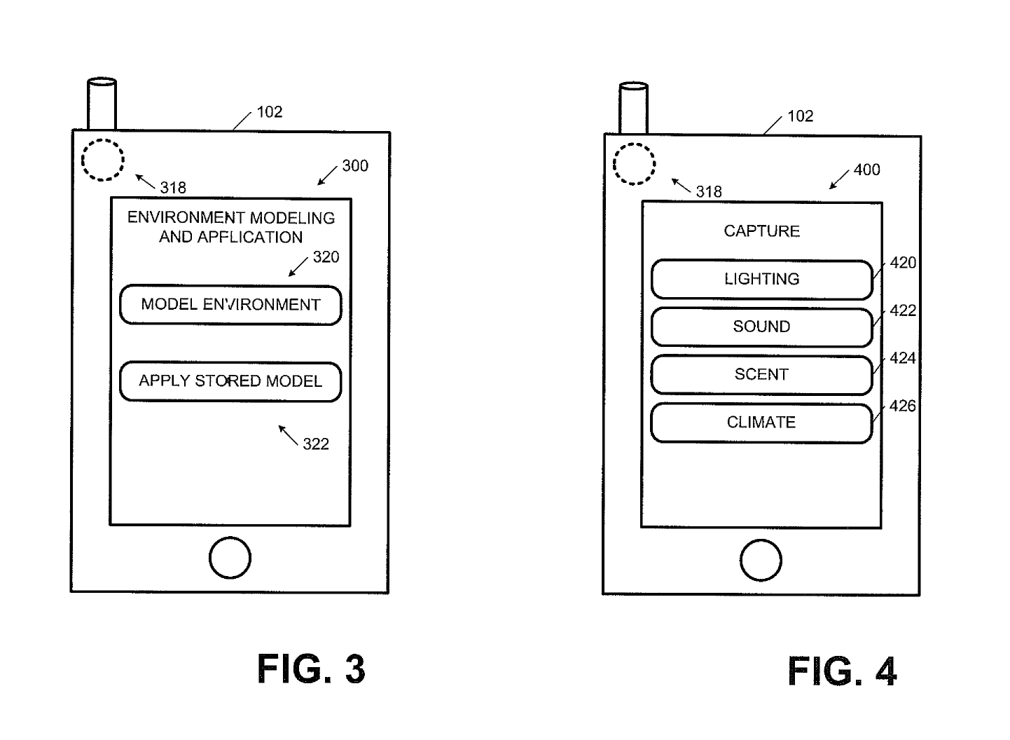

FIG. 3 depicts a user interface 300 that provides options to model an environment ambiance and apply a stored model, according to embodiments disclosed herein. As illustrated, the user computing device 102 may include a sensor device 318 and an application that provides the user interface 300. The sensor device 318 depicted in FIG. 3 represents any sensor device that may be integral to and/or coupled with the user computing device 102. More specifically, the sensor device 318 may be configured as an image capture device, a microphone, a scent sensor, a humidity sensor, a temperature sensor, an air quality sensor, wind sensor, etc.

Similarly, the user interface 300 may include a model environment option 320 and an apply stored model option 322. As described in more detail below, the model environment option 320 may be selected to facilitate capture of ambiance data from a source environment 110a. The apply stored model option 322 may be selected to apply ambiance data from the source environment 110a and apply that data to the target environment 110b.

FIG. 4 depicts a user interface 400 for determining a type of ambiance feature to capture in an environment, according to embodiments disclosed herein. As illustrated, in response to selection of the model environment option 320, the user interface 400 may be provided with a lighting option 420, a sound option 422, a scent option 424, and a climate option 428. More specifically, the user may select one or more of the options 420-428 to capture the corresponding data from the source environment 110a. As an example, by selecting the lighting option 420, the user computing device 102 may acquire lighting data via the sensor device 318, which may be embodied as an image capture device. By selecting the sound option 422, audio signals may be captured by the sensor device 318, which may be embodied as a microphone. By selecting the scent option 424, the user computing device 102 may capture scents via the sensor device 318, which may be embodied as a scent sensor. By selecting the climate option 426, the user computing device 102 may capture a temperature signal, a humidity signal, an air quality signal, a wind signal, etc. via the sensor device 318, which may be embodied as a thermometer, humidity sensor, air quality sensor, etc.

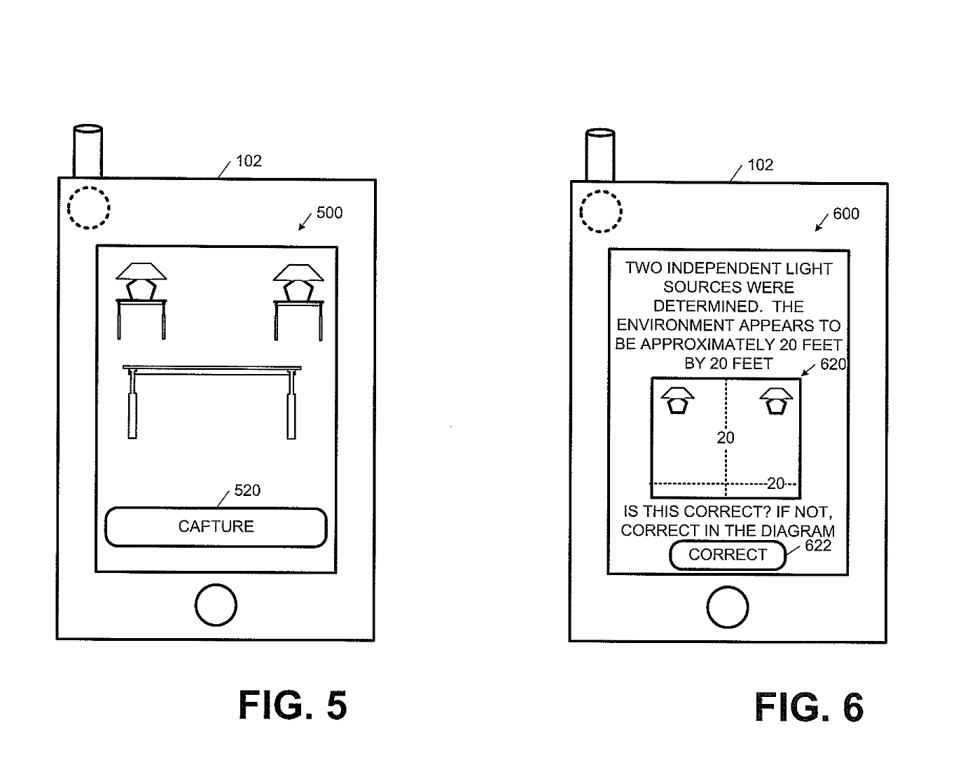

FIG. 5 depicts a user interface 500 for receiving data from the source environment 110a, according to embodiments disclosed herein. As illustrated, in response to selection of the lighting option 420, the image capture device may be utilized to capture lighting data from the source environment 110a and display at least a portion of that data in the user interface 500. By selecting the capture option 520, the image capture device may capture an image of the source environment 110a. While FIG. 5 depicts that the image data is a photographic image of the environment and source devices, this is merely an example. In some embodiments, the user interface 500 may simply provide a graphical representation of light intensity (such as a color representation). Regardless of the display provided in the user interface 500, the user computing device 102 may utilize the received ambiance feature (which in this case is lighting data) to determine source output data, such as the location, number, and intensity of light sources in the source environment 110a. Other determinations may also be made, such as size and color of the environment, whether the light sources are internal light sources (such as lamps, overhead lights, televisions, electronic components, etc.) or external light sources (such as the sun, moon, stars, street lamps, automobiles, etc.).

It should be understood that while the user interface 500 of FIG. 5 depicts the source environment 110a in the context of determining the lighting ambiance, this is merely an example. More specifically, if the sound option 422 (from FIG. 4) is selected, a microphone may be utilized to capture audio data from the source environment 110a. The user may direct the user computing device 102 across the environment. From the received audio data, the user computing device 102 can determine the source, intensity, frequency, etc. of the audio from the environment.

In response to selection of the scent option 424 (FIG. 4), the user computing device 102 may receive scent data from a scent sensor. As with the other sensors disclosed herein, the scent sensor may be integral with or coupled to the user computing device 102. Similarly, in response to selection of the climate option 426 (FIG. 4), the user computing device 102 may receive climate related data from the source environment 110a, such as via a temperature sensor, a humidity sensor, an air quality sensor, etc. With this data, the user computing device 102 can determine a climate ambiance for the source environment 110a.

FIG. 6 depicts a user interface 600 for modeling the source environment 110a, according to embodiments disclosed herein. As illustrated, the user interface 600 includes an indication of the number of output sources that were located in the source environment 110a, as well as features of the source environment 110a, itself. This determination may be made based on an intensity analysis of the output form the output source. Additionally, a graphical representation 620 of the source environment 110a may also be provided. If the user computing device is incorrect regarding the environment and/or output sources, the user may alter the graphical representation 620 to add, move, delete, or otherwise change the graphical representation 620. Additionally, a correct option 622 is also included for indicating when the ambiance features of the source environment 110a are accurately determined.

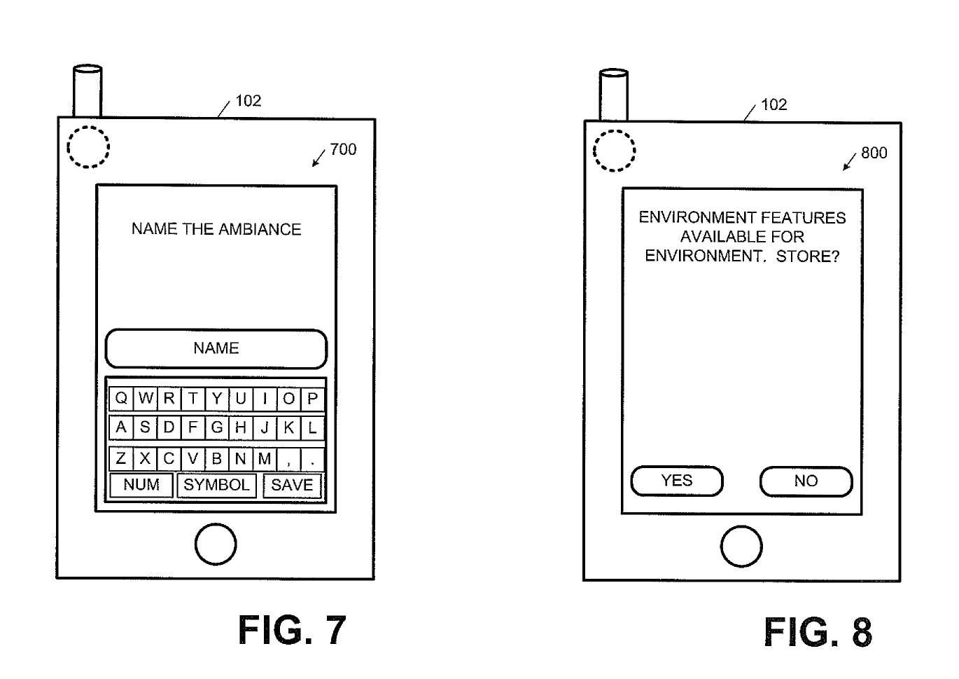

FIG. 7 depicts a user interface 700 for storing a received ambiance, according to embodiments disclosed herein. As illustrated, the user interface 700 includes keyboard for entering a name for the output source data and source environment data from FIG. 6.

FIG. 8 depicts a user interface 800 for receiving a theme from an environment, according to embodiments disclosed herein. As illustrated, the user interface 800 may be provided in response to a determination by the user computing device 102 that a source environment 110a is broadcasting a theme or other ambiance data. More specifically, the embodiments discussed with reference to FIGS. 3-7 address the situation where the user computing device 102 actively determines the ambiance characteristics of the source environment 110a. However, in FIG. 8, the user computing device 102 need not make this determination because the source environment 110a is broadcasting the ambiance characteristics (e.g., the source output data, the environment characteristics data and/or other data), such as via a wireless local area network. Accordingly, in response to receiving the ambiance characteristics, the user interface 800 may be provided with options for storing the received data.

It should also be understood that other mechanisms for receiving the ambiance characteristics of the source environment 110a. In some embodiments, the user may scan a 1-dimensional or 2-dimensional bar code to receive information pertaining to the source environment 110a. In some embodiments, the information may be sent to the user computing device 102 via a text message, email message, and/or other messaging. Similarly, in some embodiments, a theme store may be accessible over a wide area network and/or local area network for receiving any number of different themes. In the theme store, users may be provided with options to purchase, upload, and/or download themes for use in a target environment.

Additionally, some embodiments may be configured to upload and/or download ambiance characteristics to and/or from a website, such as a social media website, a mapping website, etc. As an example in the social media context, restaurant or other source environment controller may provide the ambiance characteristics on a page dedicated to that restaurant. Thus, when users visit that page, they may download the ambiance. Additionally, when a user mentions the restaurant on a public or private posting, the social media website may provide a link to that restaurant that may also include a link to download the ambiance characteristics. Similarly, in the mapping website context, a user can upload ambiance characteristics to the mapping website, such that when a map, satellite image, or other image of that environment is provided, a link to download the ambiance may also be provided.

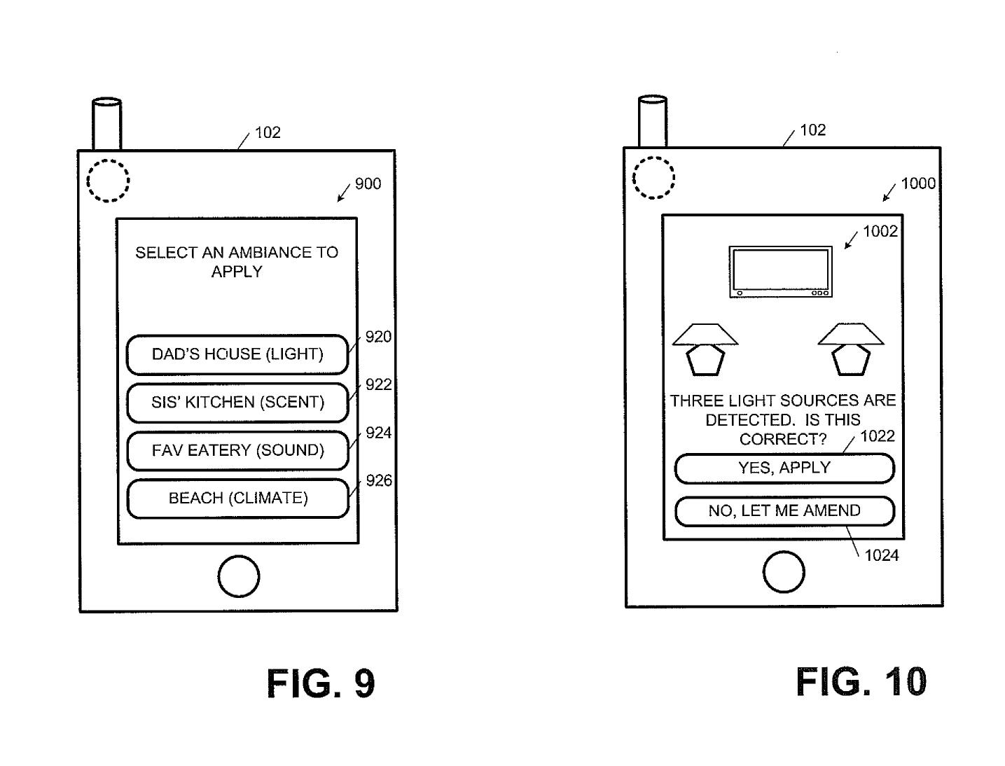

FIG. 9 depicts a user interface 900 for applying a stored ambiance to the target environment 110b, according to embodiments disclosed herein. As illustrated, the user interface 900 may be provided in response to selection of the apply stored model option 324, from FIG. 3. Accordingly, the user interface 900 may provide a “dad's house” option 920, a “sis' kitchen” option 922, a “fav eatery” option 924, and a “beach” option 926. As discussed in more detail below, by selecting one or more of the options 920-926, the user computing device 102 can apply the stored ambiance to the target environment 110b.

FIG. 10 depicts a user interface 1000 for receiving an ambiance capability for the target environment 110b, according to embodiments disclosed herein. As illustrated, the user interface 1000 may be configured to capture imagery and/or other data from the target environment 110b and utilize that data to determine an ambiance capability of the target environment 110b. The ambiance capability may be portrayed in a graphical representation 1002, which may be provided as a photographic image, video image, altered image, etc. Also included are an apply option 1022 and an amend option 1024. More specifically, by selecting the amend option 1024, the user may add, edit, move, and/or otherwise change the output sources that are provided in the user interface 1000.

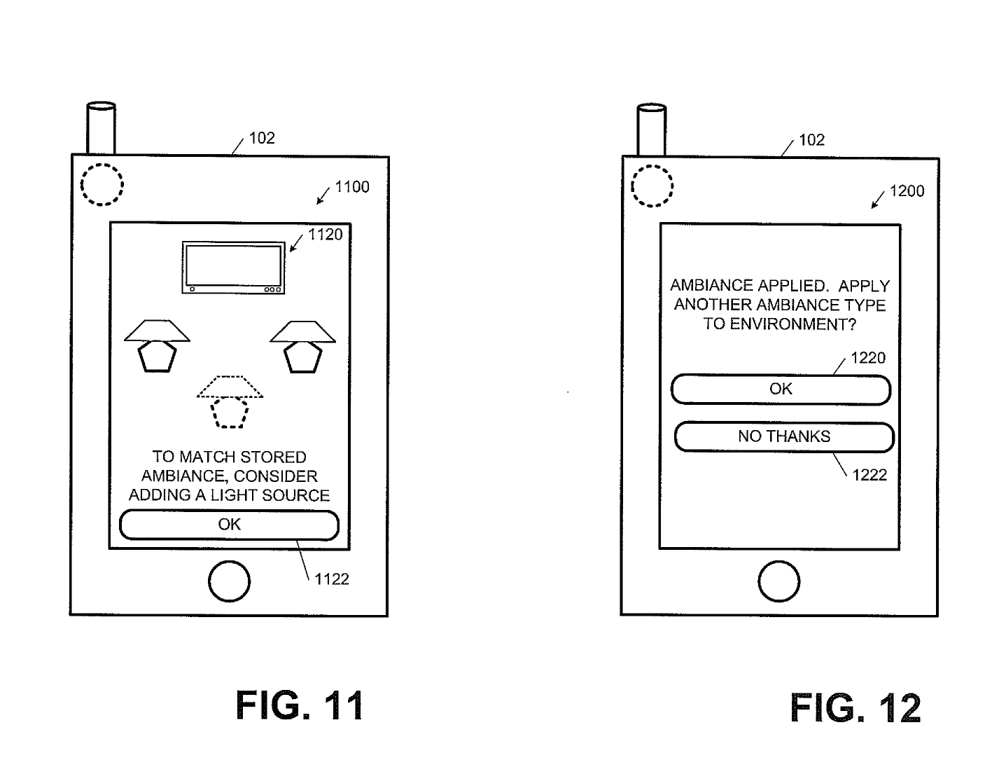

FIG. 11 depicts a user interface 1100 for providing a suggestion to more accurately model the target environment 110b according to the source environment 110a, according to embodiments disclosed herein. As illustrated, the user interface 1100 is similar to the user interface 1000 from FIG. 10, except that the user computing device 102 has determined that changes to the target environment 110b would allow a greater accuracy in modeling the ambiance from the source environment 110a. As such, the user interface 1100 may provide a graphical representation 1120, which illustrates a change and a location of that change. An option 1122 may be provided to navigate away from the user interface 1100.

FIG. 12 depicts a user interface 1200 for providing options to apply additional ambiance features to the target environment 110b, according to embodiments disclosed herein. As illustrated, the user interface 1200 may be provided in response to selection of the apply option 1022 from FIG. 10. Once the apply option 1022 is selected, the selected ambiance may be applied to the target environment 110b. More specifically, with regard to FIGS. 9-11, determinations regarding the target environment 110b have been made for more accurately customizing the desired ambiance to that target environment 110b. Once the determinations are made, the user computing device 102 may communicate with one or more of the output devices to implement the desired changes. The communication may be directly with the output devices, if the output devices are so configured. Additionally, in some embodiments, the user computing device 102 may simply communicate with a networking device that controls the output of the output devices. Upon receiving the instructions from the user computing device 102, the networking device may alter the output of the source devices.

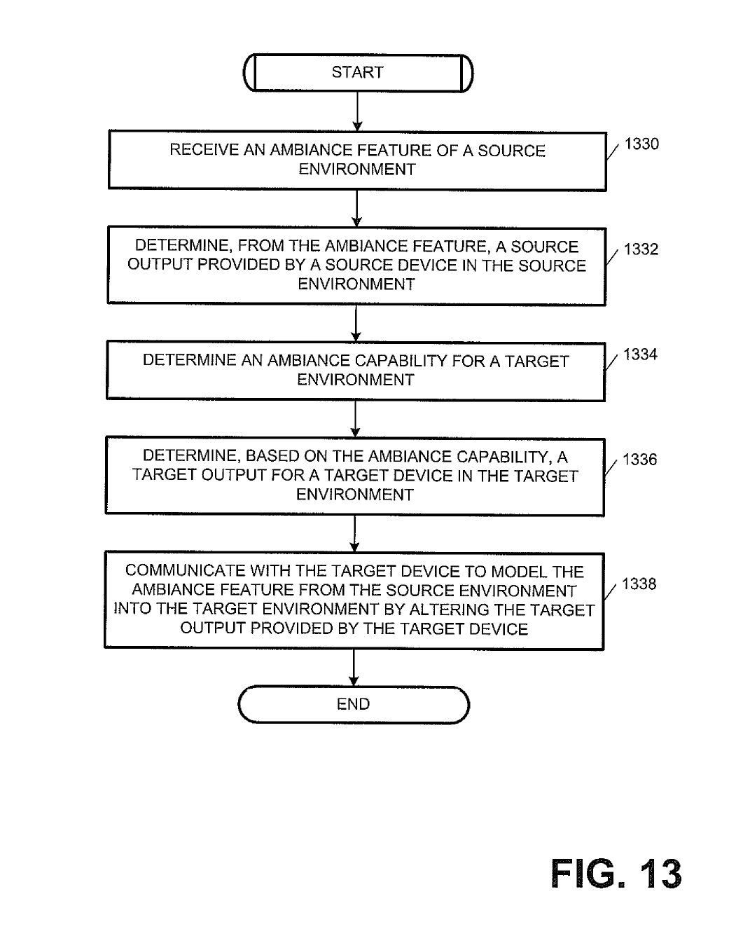

FIG. 13 depicts a flowchart for modeling an ambiance feature in a target environment, according to embodiments disclosed herein. As illustrated in block 1330, an ambiance feature of a source environment may be received. As discussed above, the ambience feature may include those features of the source environment that may be detected by the sensor device 318, such as light (e.g., an illumination signal), an audio signal, a scent signal, and a climate signal (such as temperature, humidity, air quality, etc.) and/or other features. At block 1332, a determination may be made from the ambiance feature regarding a source output provided by a source device in the source environment. More specifically, the determination may include determining a type of source device (such as a type of illumination device or other output device), where the type of illumination device includes a lamp, an overhead light, a television, a component light, sunlight, a fire, an external light source, a candle, etc. At block 1334, a determination may be made regarding an ambiance capability for a target environment. At block 1336, a determination may be made based on the ambiance capability of the target environment, regarding a target output for the target device in the target environment. The target device may include an output device, such as a light source, audio source, climate source, etc. that is located in the target environment and/or a networking device that controls the output devices. At block 1338, a communication may be facilitated with the target device to model the ambiance feature from the source environment into the target environment by altering the target output provided by the target device. In some embodiments, modeling the ambiance feature from the source environment into the target environment includes determining a number of target devices in the target environment, a location of the target device in the target environment, a type of target device in the target environment (such as a type of light source), etc. Similarly, in some embodiments the communication may include sending a command to the target device.

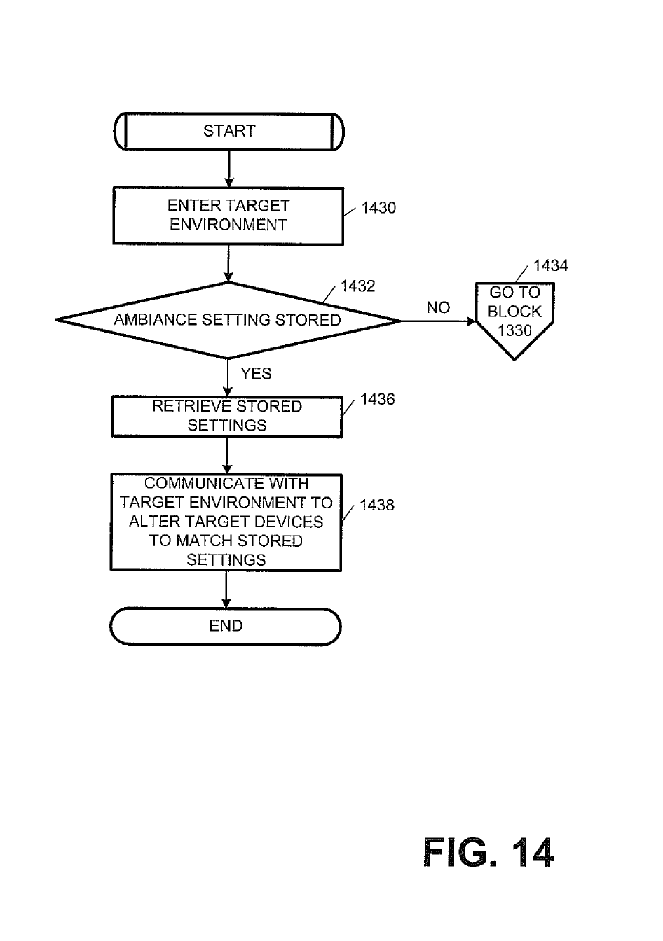

FIG. 14 depicts a flowchart for determining whether an ambiance feature has previously been stored, according to embodiments disclosed herein. As illustrated in block 1430, the user computing device 102 may enter a target environment. At block 1432, a determination may be made regarding whether an ambiance setting is currently stored. If an ambiance setting is not currently stored, the user computing device 102 may be taken to a source environment and the process may proceed to block 1330 in FIG. 13. If an ambiance setting is currently stored, at block 1436 the stored settings may be retrieved. At block 1438, the user computing device 102 can communicate with the target environment to alter target devices to match the stored settings.

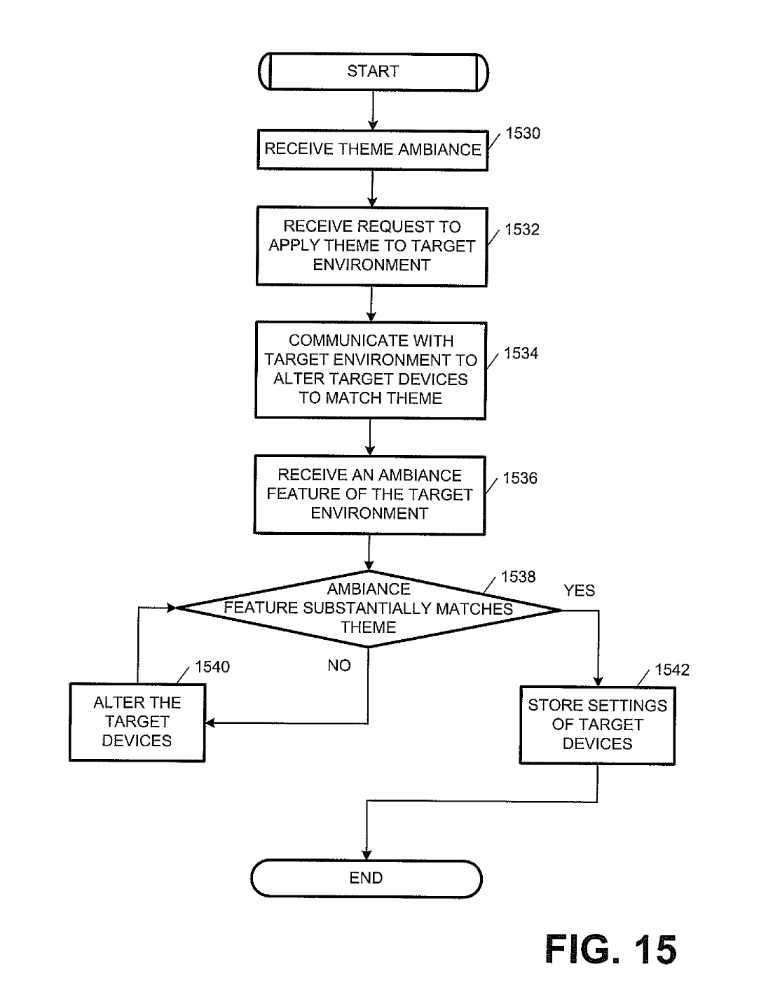

FIG. 15 depicts a flowchart for determining whether an applied ambiance feature substantially matches a theme, according to embodiments disclosed herein. As illustrated in block 1530, a theme ambiance may be received. At block 1532, a request to apply the theme to the target environment may be received. At block 1534, the user computing device 102 may communicate with the target environment to alter the target devices to match the theme. At block 1536, an ambiance feature may be received from the target environment. At block 1538, a determination may be made regarding whether the ambiance feature substantially matches the theme. This determination may be based on a predetermined threshold for accuracy. If the ambiance feature does substantially match, at block 1542, the settings of the target devices may be stored. If the ambiance feature does not substantially match, the user computing device 102 can alter the target devices to provide an updated ambiance feature (such as an updated lighting characteristic) to more accurately model the theme.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be understood to those skilled in the art that various other changes and modifications can be made without departing from the spirit and scope of the invention. It is therefore intended to cover in the appended claims all such changes and modifications that are within the scope of this invention.

What is claimed is:

1. A method for sensing and adjusting features of an environment comprising:
receiving, by a sensor device that is coupled to a user computing device, an ambiance feature of a source environment;
determining, by the user computing device and from the ambiance feature, a source output provided by a source device in the source environment;
determining an ambiance capability for a target environment;
determining, based on the ambiance capability, a target output for a target device in the target environment; and
communicating with the target device to model the ambiance feature from the source environment into the target environment by altering the target output provided by the target device.

2. The method as in claim 1, wherein the ambiance feature comprises at least one of the following: an illumination signal, an audio signal, a scent signal, a temperature signal, a humidity signal, an air quality signal, and a wind signal.

3. The method as in claim 1, in which determining the source output provided by the source device comprises determining a number and a location of source devices in the source environment.

4. The method as in claim 1, in which determining the source output provided by the source device comprises determining a type of source device, wherein the type of source device comprises at least one of the following: a light source, an audio source, a scent source, a temperature source, a humidity source, an air quality source, and a wind source.

5. The method as in claim 1, in which communicating with the target device comprises sending a command to at least one of the following: a light source in the environment, an audio source in the environment, a scent source in the environment, a climate source in the environment, and a network device in the environment.

6. The method as in claim 1, in which modeling the ambiance feature from the source environment into the target environment comprises determining at least one of the following: a number of target devices in the target environment, a location of the target device in the target environment, and a type of target device in the target environment.

7. The method as in claim 1, further comprising making a recommendation to alter the target environment to more accurately model the ambiance feature from the source environment.

8. A system for sensing and adjusting features of an environment comprising:
an image capture device for receiving an illumination signal for a source environment; and
a memory component that stores logic that causes the system to perform at least the following:
receive the illumination signal from the image capture device;
determine, from the illumination signal, an illumination ambiance in the source environment;
determine a characteristic of the source environment;
determine an illumination capability for a target environment;
determine, based on the illumination capability, a target output for a light source in the target environment; and
communicate with the light source to model the illumination ambiance from the source environment into the target environment by altering the target output provided by the light source.

9. The system as in claim 8, wherein the logic further causes the system to determine whether the illumination capability in the target environment is substantially accurate and, in response to determining that the illumination ambiance in the target environment is not substantially accurate, dynamically adjusting the light source in the target environment.

10. The system as in claim 8, in which determining the illumination ambiance comprises determining at least one of the following: a number of light sources in the source environment, a location of light sources in the source environment, and a size of the environment.

11. The system as in claim 8, in which determining the illumination ambiance comprises determining a type of light source, wherein the type of light source comprises at least one of the following: a lamp, an overhead light, a television, a component light, sunlight, a fire, an external light source, and a candle.

12. The system as in claim 8, in which communicating with the light source comprises sending a command directly to at least one of the following: the light source and a network device that controls the light source.

13. The system as in claim 8, in which determining data related to the illumination ambiance comprises sending data to a remote computing device and receiving the target output from the remote computing device.

14. The system as in claim 8, in which the logic further causes the system to send the illumination ambiance to a remote computing device for utilization by other users.

15. A non-transitory computer-readable medium for sensing and adjusting features of an environment that stores a program that, when executed by a computing device, causes the computing device to perform at least the following:
receive an illumination signal;
determine, from the illumination signal, an illumination ambiance in a source environment;
determine a characteristic of the source environment;
determine an illumination capability for a target environment;
determine, based on the illumination capability, a target output for a light source in the target environment;
communicate with the light source to model the illumination ambiance from the source environment into the target environment by altering the target output provided by the light source;
receive an updated lighting characteristic of the target environment;
determine whether the updated lighting characteristic substantially models the illumination ambiance from the source environment; and
in response to determining that the updated lighting characteristic does not substantially model the illumination ambiance from the source environment, altering the target output provided by the light source.

16. The non-transitory computer-readable medium as in claim 15, in which the logic further causes the computing device to store the updated lighting characteristic, in response to determining that the updated lighting characteristic substantially models the illumination ambiance from the source environment.

17. The non-transitory computer-readable medium as in claim 15, in which determining the illumination ambiance comprises determining at least one of the following: a number of light sources in the source environment, a location of the light source in the source environment, and a size of the environment.

18. The non-transitory computer-readable medium as in claim 15, in which determining the illumination ambiance comprises determining a type of illumination device, wherein the type of illumination device comprises at least one of the following: a lamp, an overhead light, a television, a component light, sunlight, a fire, an external light source, and a candle.

19. The non-transitory computer-readable medium as in claim 15, in which communicating with the light source comprises sending a command directly to at least one of the following: the light source and a network device that controls the light source.

20. The non-transitory computer-readable medium as in claim 15, in which determining data related to the illumination ambiance comprises sending data to a remote computing device and receiving the target output from the remote computing device.
